(19) United States
(12) Patent Application Publication
(10) Pub. No.: US 2010/0266438 A1
(43) Pub. Date: Oct. 21, 2010

(54) METHOD AND DEVICE FOR PRODUCING ANNULAR, ROTATIONALLY SYMMETRICAL WORKPIECES MADE OF METAL AND/OR CERAMIC POWDER

(75) Inventor: Hilmar Gensert, Bad Duben (DE)

Correspondence Address: LERNER GREENBERG STEMER LLP, P O BOX 2480, HOLLYWOOD, FL, 33022-2480, US

(73) Assignee: SIEBER FORMING SOLUTIONS GMBH, Henstedt-Ulzburg (DE)

(21) Appl. No.: 12/747,962

(22) PCT Filed: Dec. 3, 2008
(86) PCT No.: PCT/EP08/10219

§ 371 Date: Jun. 14, 2010

(30) Foreign Application Priority Data
Dec. 14, 2007 (DE) 10 2007 060 964.9

(51) Int. Cl. B22F 3/24; B28B 1/30

(52) U.S. Cl. 419/28; 264/482; 425/174.4

(57) ABSTRACT

An economical, low-effort method and device for producing annular, rotationally symmetrical workpieces, rings or cores for dies of metal and/or ceramic powder or for pressing powder or massive forming of workpieces or components of metal with different qualities. A beam core or shaft-shaped element having at least one beam core is clamped into a rotatable clamping device and rotated. The beam core is made of temperature-resistant material and has at least one segment with an outer diameter corresponding to or smaller than the inner diameter of the workpieces. Metal and/or ceramic powder is fused onto the jacket surface of the beam core at a defined distance from the clamping fixture by a laser and applied in layers until a final wall thickness of the workpiece blank. After cooling, the beam core is partially or completely removed from the blank which is machined on inner and/or outer sides to final dimensions.

The invention relates to a method for producing annular, rotationally symmetrical workpieces, such as rings or cores for dies, made of metal and/or ceramic powder, particularly for dies for pressing powder or massive forming of workpieces or components made of metal. The invention also relates to a suitable device for carrying out the method.

Massive forming (cold or hot forming) is widely used in industrial applications for the mass production of components made of metal, such as aluminium or steel. High forming forces occur in the processes involved in massive forming and extremely high mechanical demands are placed on the forming dies because of the large production batches involved, with the process limits governed in most cases by a high tool wear. The surfaces of die and workpiece have a critical influence on the tribological conditions and thus the process limits, process stability and the service life of the die. Materials based on cemented carbides or ceramic are therefore used for making forming dies.

Cemented carbides are composite materials consisting of a combination of metallic hard materials, such as carbides of the metals tungsten, titanium, tantalum and/or vanadium, and binders or metallic binders with relatively soft, ductile metals, such as cobalt or nickel, with hard materials forming the highest proportion of the constituents. Different properties can be created by different combinations of binders, hard material, grain size and amounts.

To produce cemented carbides the starting materials are ground and mixed, pressed to form moulds or intermediate shapes and subsequently sintered under inert gas or vacuum at temperatures exceeding approximately 1300 to 1550° C. and are then usually repressed. The moulds or intermediate shapes produced in this way must still subsequently be machined to achieve the final dimensions.

To produce carbide rings or cores for dies the cemented carbide powder composition is pressed to form rings. The carbide rings are machined as a final process.

Ceramic rings are produced in a similar way, starting with powder, followed by plastic moulding and subsequent sintering.

The method referred to above for producing carbide or ceramic rings is technologically very complicated and is economical only for very large scale production. To form the pressed ring blanks separate pressing dies are required for each dimension. This method is unsuitable for economic reasons for the small scale production of a large number of differently sized rings of different qualities.

The aim of the invention is to devise a method for producing annular blanks made of metal and/or ceramic powder that is technically less complicated and enables conversion to be made to different qualities at short notice. In addition, a suitable device for carrying out the method is to be devised.

This aim is achieved according to the invention by means of the features specified in claim 1. Advantageous embodiments and developments are the subject of claims 2 to 14.

A suitable device for carrying out the method is the subject of claim 15. Claims 16 to 24 relate to advantageous embodiments of the device.

Rotationally symmetrical workpieces, such as cores for dies with an internal diameter of 5 to 50 mm and an external diameter of 15 to 150 mm, are produced by primary forming using a “lost core” as a beam core.

The term die per se is understood to mean a tool consisting of a core with a die cavity and at least one reinforcement. In the technical literature, however, the term die is also used to describe the core or the actual forming die. The beam core or a shaft-shaped element with at least one beam core is clamped into a rotatable clamping device and caused to rotate, preferably at a rotational speed of 50 to 300 min⁻¹. The beam core has at least one segment whose external diameter corresponds to the internal diameter of the workpiece to be produced and is made of high temperature-resistant material.

Metal and/or ceramic powder is fused onto the jacket surface of the beam core at a defined distance from the clamping fixture by means of a laser head, and applied in layers until the final wall thickness of the workpiece blank has been formed. After cooling, the beam core is partly or completely removed from the workpiece blank. The blank is then machined on its external sides to achieve the final dimensions. This method enables rotationally symmetrical workpieces to be produced very economically in small scale production. Compared with the known methods, pressing the workpieces in a mould or machining a cemented carbide blank considerably reduces production times because of the smaller number of machining operations involved. The workpieces to be produced are in most cases dies made of cemented carbides for massive forming that are exposed to a range of high mechanical loads.

By selecting suitable grades of powder, the manufacturer of the dies can now respond quickly to special requests by customers for the required strength properties for individual dies and can therefore guarantee short delivery times.

The application of metal powder fused by means of a laser head is known per se as build-up welding and is used for applying special wearing surfaces on prefabricated workpieces or for carrying out repairs by replacing worn workpiece surfaces. The known coating devices for this process consist of a laser with a laser head and a powder feed with the powder fed in coaxially and fused at the working point of the laser.

The proposed method enables rotationally symmetrical forming dies, such as rings or cores to be produced by the workpiece being completely built-up in the form of layers. Dependent on the length of the workpiece the fused powder is applied in a spiral coiling fashion onto the rotating beam core in the form of several rotating, overlapping beads until the final wall thickness of the workpiece has been formed. The individual beads of the overlapping layers can be applied congruently or offset to one another. A material composition based on metal or ceramic powder or even a mixture of both components can be used to build up the workpiece or the layer can also be built up using different material compositions. The latter option enables workpieces to be built up with radially different strength properties. The different materials should be coordinated with each other in such a way in this process that they combine with each other to form one unit by metallurgical fusion.

The beam core used consists of a high temperature-resistant material, preferably carbon electrode material or steel that is markedly softer than the material used for building up the layer. The beam core has at least one segment whose external diameter corresponds to or is slightly smaller than the internal diameter of the workpiece to be produced. The difference in size in the case of a smaller external diameter is so calculated that sufficient material is left for machining the internal surfaces of the workpiece blank to its final dimensions. The beam core can be formed with a different external shape. A rod-shaped beam core is used to produce dies with a small internal diameter. The beam core can be constructed of such a length that several workpieces can be produced on it simultaneously, using one or even several laser heads. A certain distance is to be maintained between the individual workpieces during the forming operation. The beam core can have segments of different diameters, enabling workpieces with different internal diameters to be produced on one beam core.

The beam core can also be fitted in the area of the build-up of the workpiece with a corresponding contour as a negative to form the internal shape or contour of the workpiece. The area of the beam core where the workpiece is built up can also have segments of different external diameters on which a layer can be built up with different wall thicknesses so that the internal contour of the die is formed in a series of steps.

The beam core can also be formed as a sleeve attached to a shaft. One part of the shaft is clamped into the chuck. The sleeve can, for example, be detachably connected to the shaft. The advantage of this variant is that the sleeve is detached from the shaft after the layer has been built up, leaving only the sleeve to be removed from the workpiece. This is advantageous especially with workpieces with relatively large internal diameters. The shaft can be fitted with a new sleeve for reuse.

The beam core need not consist of just one material. It can also be formed as a composite made from different materials. The beam core can consist of two segments of different materials to produce cup-shaped workpieces, with the segment protruding from the clamping device made of cemented carbide and remaining in the workpiece to form part of the base. In this case only the rear segment of the carrier material is removed from the workpiece.

To produce workpieces with different dimensions the beam core should have an additional segment for measuring the workpiece, with the control of the course of movement of the coating unit then being based on this measurement.

The beam core is heated to approximately 350 to 450° C. for example before the actual build-up of the workpiece. The temperature depends on the fusion temperature of the powder. A release agent can additionally be applied to the beam core before the actual build-up of the layer.

During the build up of the workpiece in layers, either the laser head or clamping device is continuously or intermittently moved in the direction of the workpiece in both directions. The laser head and clamping device can also be moved.

The metal or ceramic powder is fused using a laser head known from laser cladding which has a CO₂ or diode laser with an output of 500 to 1500 W. The powder is fed coaxially under an inert gas atmosphere, with the powder fused at the working point of the laser beam by the formation of a powder jet focused on the laser spot size. The fused powder applied quickly cools down again. The laser parameters to be set are dependent on the powder material used. Preferably, cemented carbides or high speed steels should be used as metal powder. The fused metal can also be applied under a vacuum.

After the layer has been built up, the beam core is removed again—by ultrasonic treatment if it is made of carbon electrode material or by machining if it is made of soft grades of steel.

The workpieces produced, which are solid components with no porous structure, are then further machined on their external sides or machined by electrical discharge in order to obtain the required final dimensions.

The invention is to be explained below by means of an execution example. The figures in the associated drawing show the following:

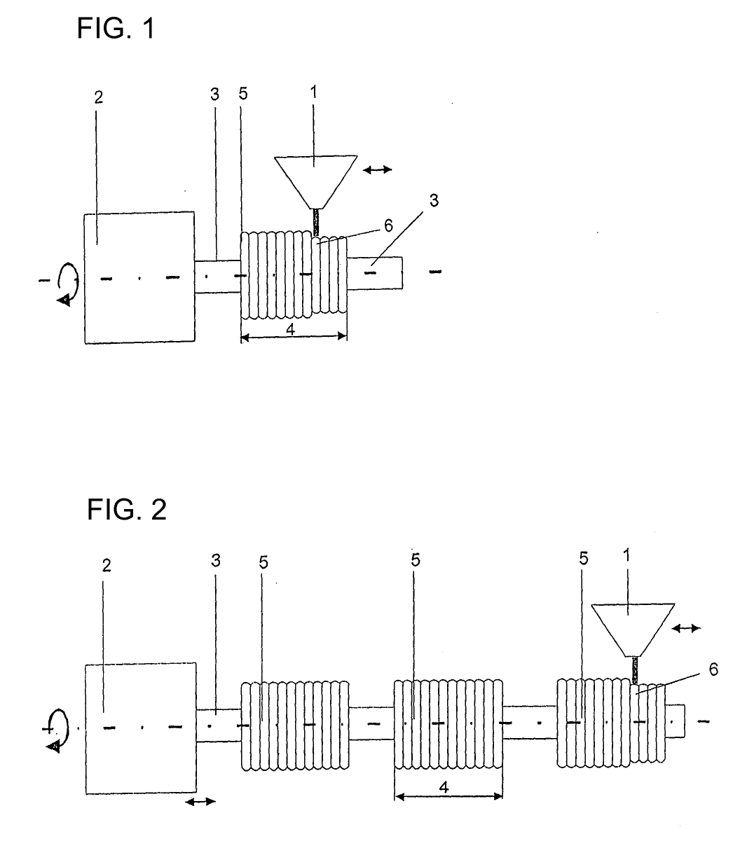

FIG. 1 a simplified representation of an initial embodiment of the device for producing a die core,

FIG. 2 a simplified representation of a second embodiment of the device for producing several die cores,

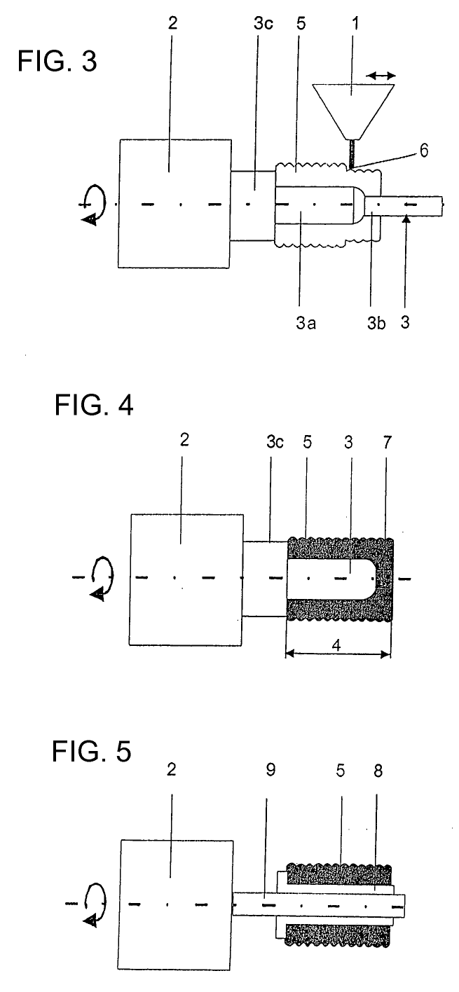

FIG. 3 a simplified representation of a third embodiment of the device for producing a die core with a different internal contour,

FIG. 4 a simplified representation of a fourth embodiment of the device for producing a cup-shaped die core, and

FIG. 5 a simplified representation of a fifth embodiment of the device for producing a die core.

FIG. 1 shows a device for producing an annular die core 5 for a forming die in a simplified representation. The device consists of a coating unit known per se with a laser head movable in a longitudinal direction with cemented carbide or ceramic powder fed into the working point of the laser beam and a rotatable clamping device 2 into which a rod-shaped beam core 3 made of carbon electrode material is clamped. The beam core 3 has a segment 4 which is intended for building up the workpiece and whose external diameter is slightly smaller than the internal diameter of the die core 5 to be produced. The device also includes a post-processing unit which is not shown for removing the beam core 3 from the completed raw die core 5 and for the concluding machining of the internal and external surfaces of the core 5.

During the rotation of the beam core 3 the cemented carbide powder fused by the laser head is applied as a continuous bead 6 to the segment 4 of the beam core 3 by a spiral coiling process. The rotation of the beam core 3 and the to-and fro movement of the laser head of the coating unit 1 enable the die core workpiece 5 to be built up in layers by the overlapping beads 6 as a forming process. As the layers are built up, the laser head or the coating unit 1 moves slowly away from the workpiece in a radial direction. FIG. 2 shows an embodiment variant in which three die cores 5 are produced in succession on the beam core 3. In this case the clamping device 2 can also be constructed so as to be movable in a longitudinal direction. Three coating units or laser heads can also be arranged instead of one coating unit 1 so that all three die core workpieces 5 can be built simultaneously.

FIG. 3 shows an embodiment for producing a die core 5 with segments of different internal diameters. The beam core 3 has segments 3a, 3b of different external diameters adjusted to the internal contour of the die core 5. The beam core 3 also has a segment 3c with an enlarged external diameter which is arranged between the chuck 2 and the segment 4 for building up the workpiece and serves as a frontal limiting surface for the die core to be produced. Such a segment is always required as a dimensional reference for setting the movement of the coating unit if the internal contour of the workpiece to be produced is of different dimensions.

FIGS. 4 and 5 show two further embodiments in which the coating unit is not shown.

FIG. 4 shows the production of a cup-shaped raw die core 5. The beam core 3 has at its protruding end a segment 7 made from cemented carbide. After the die core 5 has been built up, this segment 7 remains in the die core 5 and is not removed with the beam core. During the production of the cup-shaped die core 5, one or more beads of the fused cemented carbide fed in are initially “coiled” around the cemented carbide segment 7 until the external circumference of the beam core 3 is reached. A further “coiling process” then takes place over the entire length of the segment 4 of the beam core 3 until the die core 5 has been completely built up.

FIG. 5 shows an embodiment for producing an annular die core 5 with a beam core formed as a sleeve 8. The sleeve 8 made of carbon electrode material is detachably fastened to a shaft-shaped element 9. The external jacket surface of the sleeve 8 forms the segment for building up the die core 5. After the die core 5 has been completed, it is removed together with the sleeve 8 from the shaft-shaped element 9 and the sleeve 8 is subsequently removed by drilling in the post-processing unit. The shaft-shaped element can be reused for a further production process.

The method is explained below using the example of the production of an annular die insert (die core) for a forming die made from cemented carbide (tungsten carbide nickel) with an internal diameter of 20 mm, an external diameter of 40 mm and a width of 20 mm.

The beam core made of graphite (carbon electrode material) can be exposed to air temperatures up to 400° C. and up to 2500° C. under inert gas. It has good non-wetting properties compared with many metal melts and therefore prevents bonding caused by metallurgical fusion between the carrier material and the metal powder. One side of the beam core with an external diameter of 20 mm and a length of 80 mm is clamped into a rotatable clamping device (free clamping length approximately 30 mm) and the end segment (approximately 30 mm) is heated to approximately 400° C. by means of an external heating device. The clamping device is caused to rotate (100 min⁻¹). A tungsten carbide nickel (WC—Ni) powder mixture (16 to 18% Ni and 5 to 5.2% C) focused to the laser beam is fed to the laser head, which is movable in both longitudinal directions and can be moved upwards and downwards, in order to build up the workpiece under an inert gas atmosphere. This mixture is then fused in the working point of the laser beam and applied as a liquid melt with a bead width of approximately 2 mm to the segment of the beam core intended for building up the workpiece. In this process the laser head is continuously moved to and fro at a very slow speed within each cycle. After the end of a cycle, which is a path of movement of approximately 20 mm, a layer is formed with the formation of 10 rotating adjoining beads. Drop formation is eliminated because of the very rapid cooling of the melt applied. The fused metal powder is applied to the beam core in a kind of “coiling process”. In further cycles the layers are built up continuously layer by layer until the final external diameter is reached. The individual beads and layers combine to form a uniform structure by metallurgical fusion. After the required external diameter has been reached with the formation of a small excess, the forming process is ended.

It takes approximately 10 minutes to produce a ring with a wall thickness of 20 mm and a width of 20 mm. The beam core with the annular workpiece blank is removed from the clamping device and the protruding part of the beam core cut off. The residual part of the beam core still remaining in the workpiece is then removed by drilling. Finally, the workpiece blank is ground on its internal and external sides until the final dimensions are reached.

1-24. (canceled)

25. A method for producing rings or cup-shaped cores, as rotationally symmetrical workpieces, made of cemented carbide and/or ceramic powder, for dies, for workpieces for massive forming or for pressing powder, the method comprising the following steps:
providing a beam core made of high temperature-resistant material having at least one segment with an external diameter corresponding to or being smaller than an internal diameter of the workpiece to be produced;
clamping the beam core or a shaft-shaped element with at least one beam core into a rotatable clamping device and rotating the beam core;
fusing metal and/or ceramic powder onto a jacket surface of the beam core at a defined distance from the clamping device with a laser head and applying the fused powder in layers until a final wall thickness of a workpiece blank has been formed;
partly or completely removing the beam core again from the workpiece blank after cooling; and
machining internal and/or external sides of the blank to achieve final dimensions.

26. The method according to claim 25, which further comprises applying the fused powder in a spiral coiling process in the form of several rotating overlapping beads to build up the wall thickness in layers, in dependence on a length of the workpiece.

27. The method according to claim 25, which further comprises fitting an external shape of the beam core with a contour forming an internal shape of the workpiece to be produced, in an area of build-up of the workpiece.

28. The method according to claim 25, which further comprises coating the beam core with a release agent in an area of build-up of the work-piece.

29. The method according to claim 25, which further comprises forming several workpiece blanks at defined distances on the beam core.

30. The method according to claim 25, which further comprises forming the beam core of carbon electrode material.

31. The method according to claim 25, which further comprises providing the beam core with segments of different external diameter being adjusted to respective internal contours of the workpiece to be produced.

32. The method according to claim 25, which further comprises providing the beam core with segments of different external diameters on which a layer with different wall thicknesses is built up.

33. The method according to claim 25, which further comprises heating the beam core before the fused material is applied.

34. The method according to claim 25, which further comprises using a single powder composition of cemented carbide and/or ceramic to form individual layers of a workpiece.

35. The method according to claim 25, which further comprises using different powder compositions of cemented carbide and/or ceramic to form individual layers or sections of layers of a workpiece.

36. The method according to claim 25, which further comprises continuously or intermittently moving the laser head and/or the clamping device in direction of the workpiece in two directions during a buildup of the workpiece by layers.

37. The method according to claim 25, which further comprises forming the beam core of at least two segments of different materials, including one segment remaining in the workpiece and another segment being removed.

38. The method according to claim 25, which further comprises using a sleeve detachably connected to the shaft-shaped element, as the beam core.

39. A device for carrying out the method according to claim 25 by producing rings or cup-shaped cores, as rotationally symmetrical workpieces, made of cemented carbide and/or ceramic powder, for dies, for workpieces for massive forming or for pressing powder, the device comprising:
at least one coating unit having a movable laser head with a laser beam working point into which cemented carbide and/or ceramic powder is fed;
a rotatable clamping device;
a beam core to be clamped into said clamping device or a clampable, shaft-shaped element with a beam core;
said beam core being made of high temperature-resistant material and having at least one segment for building up the workpiece, said at least one segment having an external diameter corresponding to or being smaller than an internal diameter of the workpiece to be produced; and
a post-processing unit for removing said beam core and machining internal and/or external sides of the workpiece to achieve final dimensions.

40. The device according to claim 39, wherein said at least one segment of said beam core for building up the workpiece has a contour forming an internal shape of the workpiece.

41. The device according to claim 39, wherein said at least one segment of said beam core is several segments for building up workpieces, said segments being disposed at a defined distance from each other.

42. The device according to claim 39, wherein said at least one segment of said beam core is several segments with different external diameters being adjusted to respective internal contours of the workpiece.

43. The device according to claim 39, wherein said at least one segment of said beam core is a plurality of segments of different materials.

44. The device according to claim 39, wherein said beam core is formed as a sleeve being detachably connected to said shaft-shaped element.

45. The device according to claim 39, wherein said beam core, being removable from the workpiece is formed of a material being softer than a material of the workpiece.

46. The device according to claim 39, wherein said clamping device is disposed on a slide movable in a longitudinal direction.

47. The device according to claim 39, wherein said beam core has an end protruding from said clamping device and said end has a segment made of cemented carbide remaining in the workpiece.

48. The device according to claim 39, wherein said beam core has a segment which serves to measure the workpiece.
